(19) United States
(12) Patent Application Publication
(10) Pub. No.: US 2009/0208692 A1
(43) Pub. Date: Aug. 20, 2009

(54) LIMITED LIFE OPTICAL MEDIA

(75) Inventors: Edward Lindholm, Brookline, MA (US); Louis Cincotta, Andover, MA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: FLEXPLAY TECHNOLOGIES, INC., Atlanta, GA (US)

(21) Appl. No.: 12/336,864

(22) Filed: Dec. 17, 2008

Related U.S. Application Data
(60) Provisional application No. 61/014,217, filed on Dec. 17, 2007.

(51) Int. Cl. B32B 9/04

(52) U.S. Cl. 428/64.4

(57) ABSTRACT

Optical media of a limited usable life are disclosed. The invention relates to chemical formulations and methods and processes for creating time limiting mechanisms for the inclusion in optical media thereby providing optical media with a limited usable life in which encoded information may be accessed, played and/or read for a prescribed limited time. The invention provides formulations and methods for corrosion of and/or the corrosive degradation of a reflective layer(s) and/or reflective material of optical media such that the encoded information stored on an optical medium can not longer be read by a reading beam.

### CROSS-REFERENCE TO RELATED APPLICATIONS

This application claims the benefit of U.S. Provisional Application No. 61/014,217, filed Dec. 17, 2007, the entire contents of said application is hereby incorporated by reference.

### BACKGROUND OF INVENTION

In optical media, a reading laser must be reflected back to the read optics of a player or reading device by reflective layer(s) within or on the optical media, so that the encoded information stored thereon can be read. The reflective layer(s) can be only reflected material capable of reflecting a reading laser to the read optics in such as manner so as to read the encoded information. Metallic reflective layers are much less sensitive to laser wavelength while dielectric films can be created which will be transparent at one wavelength while reflecting another. Both types of reflective layers can be used in optical media.

There are certain applications where it is desirable to limit the length of time the encoded information stored on an optical medium can be accessed, played and/or viewed. For example, movie rental applications; wherein as a convenience to a consumer a movie may be purchased at a rental price without the requirement of membership to a particular store and/or service. The movie stored thereon will have limited amount time or number of plays in which it can be viewed before the movie becomes permanently and irreversibly inaccessible and thus unviewable. Current solutions include the replication of an optical disc with a reactive dye material wherein the dye absorbs the reading beam in part thereby prohibiting the reading of the encoded information. The drawback to these solutions is that the dye material must be tuned to the particular wavelength of the reading beam such that it is sufficiently matched to the reading beam and thereby absorbed.

What is needed is a solution that limits the lifetime of an optical medium that is independent of the wavelength of the reading beam, such that it can be used across all types of optical media, for example but not limited to, CD, CD-R, Holographic optical media, DVD, HD-DVD, Blu-Ray and recordable DVD (DVD-R)

### SUMMARY OF INVENTION

In the present invention, optical media is disclosed wherein access to encoded information therein is limited, irreversibly, by affecting the reflectivity of the semi-reflective and/or reflective layers. In the present invention the reflective layer may be selected from any metal, combination of metals, reflective dielectric film or films (e.g. SiN) or other reflective material capable of undergoing the required/desired redox reaction in the presence of oxygen or after the addition of oxygen to the system.

The chemistry and examples described throughout for limiting the play time and thus the lifetime of optical media are independent of the read laser wavelength, i.e., will operate regardless of the read laser wavelength, and provide limited-play capabilities via corrosive destruction, in all optical media formats that utilize reflective layers capable of undergoing the required/desired redox reaction in the presence of oxygen or after the addition of oxygen including but not limited to for example, CD, Holographic optical media, DVD, HD-DVD, Blu-Ray and recordable DVD (DVD-R) and additional optical media wherein a reflective layer is employed to reflect encoded information to a reading device using a focused or other controlled beam(s) of radiation.

### BRIEF DESCRIPTION OF THE DRAWINGS

FIG. 1 is a graph showing the increase in optical transmission (% T) of L0 layer within simulated DVD-9 with 1% MBI bonding agent during 7 days at ambient conditions.

FIG. 2 illustrates the chemical structures of sulfur containing compounds tested for corrosion activity in simulated DVD-9 discs.

FIG. 3 is a chart showing the comparison of the increase in light transmission at 1000 nm that occurred after 48 hours of ambient air storage of the simulated DVD-9 discs that contained the various sulfur containing agents shown in FIG. 2 in the bonding agent layer

FIG. 4 is chart showing bonding agent formulations that were used in Experimental Example 1.

FIG. 5 is a chart showing the playability comparisons for the limited-play discs made with the bonding agents of FIG. 4.

FIG. 6 is a chart showing the playability comparisons for the limited-play discs made with the silver reflective layer L0's of varying thickness of Experimental Example 2.

FIG. 7 is a chart showing the preparation and properties of C100 Bonding Agent, which were combined at room temperature under subdued lighting and then heated to 6° C. for 2 hours to fully dissolve the MBI and then allowed to cool to room temperature and stored in the dark.

FIG. 8 is a chart showing preparation and properties of C101 Bonding Agent, which were combined at room temperature under subdued lighting and then heated to 60° C. for 2 hours to fully dissolve the MBI and then allowed to cool to room temperature and stored in the dark.

FIG. 9 is a graph showing the change in % T at 1000 nm vs. hours in air at room temperature for simulated DVD-9 discs containing control C100 bonding agent and the test bonding agent that contained TPG.

FIG. 10 is a graph showing the change in % T at 1000 nm vs. hours in air at room temperature for simulated DVD-9 discs containing control C100 bonding agent with 10% added TPG and the test bonding agent that contained 10% nominally added TPG and 5% nominally added water.

FIG. 11 is a graph showing the change in % T at 1000 nm vs. hours in air at room temperature for simulated DVD-9 discs containing control C100 bonding agent with 10% added TPG and the test bonding agent that contained 10% nominally added TPG and 1% nominally DMSQ.

FIG. 12 is a graph showing the change in % T at 1000 nm vs. hours in air at room temperature for simulated DVD-9 discs containing control C100 bonding agent with 10% added TPG and the test bonding agent that contained 10% nominally added TPG and 1% nominally DMSQ.

FIG. 13 is a chart showing bonding agent formulations that were used in Experimental Example 2.

FIG. 14 is a chart showing playtime results for Experimental Example 2.

FIG. 15 is a chart showing bonding agent formulations that were used in Experimental Example 3.

FIG. 16 is a chart showing playtime results for Experimental Example 3.

FIG. 17 is a graph showing optical transmission spectra of simulated DVD-9 discs after 168 hours at 85% RH at room temperature (Experimental Example 4).

FIG. 18 is a graph showing optical transmission spectra at 1000 nm of simulated DVD-9 discs after 168 hours at 85% RH at room temperature (Experimental Example 4).

FIG. 19 is a graph showing the increase in the optical transmission spectra at 1000 nm vs. time at 60° C. in air of simulated DVD-9 discs containing DBTU, chloroacetic acid varying levels of stannous octanoate (see Experimental Example 5).

FIG. 20 is a graph showing the change in % T at 1000 nm vs. hours in air at room temperature for simulated DVD-9 discs containing control C100 bonding agent with 10% nominally added TPG and the test bonding agent that contained 10% nominally added TPG and 1% nominally added octanoic acid

FIG. 21 is a graph showing the change in % T at 1000 nm vs. hours in air at room temperature for simulated DVD-9 discs containing control C100 bonding agent with 10% nominally added TPG and the test bonding agent that contained 10% nominally added TPG and 0.25% nominally added AMPS.

FIG. 22 illustrates the chemical structures of chloro compounds that were tested for corrosion activity in simulated DVD-9 discs that also contained MBI.

FIG. 23 is a graph showing the change in % T at 1000 nm vs. hours in air at room temperature for simulated DVD-9 discs that were made with bonding agents that contained 0.25% of the reactive chloro-agents shown in FIG. 22 in C100 adhesive that contained 10% TPG and 2% MBI.

FIG. 24 is a graph showing the change in % T at 1000 nm vs. hours in air at room temperature for simulated DVD-9 discs that were made with bonding agents that contained 0.25% of the reactive chloroalkanes in C100 adhesive that contained 10% TPG and 2% MBI.

FIG. 25 is a chart showing the formulation for bonding agent that was used to make the DVD-9 discs of Experimental Example 6, wherein the stannous octanoate was dissolved in the tripropylene glycol prior to addition.

FIG. 26 is a chart, showing the playtimes of the DVD-9 discs that were made from the bonding agent of FIG. 25.

FIG. 27 is a graph showing the % T spectra taken after discs were kept at 85% Rh for 114 hrs.

FIG. 28 is a graph showing the % T spectra taken after discs were kept at 60° C. for 72 hrs.

FIG. 29 is a chart showing the playtime results of discs made with basic and acidic additives.

FIG. 30 is a graph showing the change, in % T at 1000 nm vs hours in air at room-temperature for simulated DVD-9 discs containing control adhesive (1% MBI, 2% H₂O, 2% acrylic acid and 10% TPG) and the additives ethyl salicylate and ascorbyl palmitate.

FIG. 31 is a graph showing the change in % T at 1000 nm vs hours in air at room temperature for simulated DVD-9 discs containing control adhesive (1% MBI, 2% H₂O, 2% acrylic acid and 10% TPG) and the additives 3-hydroxybenzoic acid and ascorbyl palmitate.

FIG. 32 is a graph showing the changes in optical transmission (% T) of the recording dye in standard DVD-R following migration of dye away from the polycarbonate substrate to the adhesive bonding layer.

FIG. 33 is a photograph showing dye migration to bonding layer (left) following corrosion after 8 days at 85% RH.

FIG. 34 is a chart showing bonding agent formulations that were used in time limited recordable DVD example, wherein Formulation A is a control without the active corrosion chemistry components (MBI, TPG, Acrylic Acid) of Formulation B.

### DETAILED DESCRIPTION

The reflective layer can be irreversibly altered by oxidation or destruction of its reflective properties as a result of pitting, corroding, dissolution, etc., or any combination of these. (See U.S. Pat. Nos. 6,434,109, 6,343,063, 6,011,772, 6,641,886, 6,511,728, 6,537,635, 6,678,239, 6,756,103, and 5,815,484 and U.S. Patent Application Nos. 20030152019, 20030123379; 20030123302, 20030213710, 20030129408, 20030112737, Ser. Nos. 10/649,504, 10/162,417, 10/163,473, 10/163,855, 10/163,472, 10/837,826, 10/163,821, 10/651,627 and 20010046204, hereinafter incorporated by reference in their entirety.). It should be pointed out that it is not essential in all applications that the time limiting mechanism cover or be present throughout the entire area of or layer the disc and/or media. The mechanism may be configured in such a manner that it inhibits the reading of areas containing critical information content. Various patents disclose that a reactive component or components can be applied to the disc at several locations (on the surface of the disc, on the surface of the reflecting layer itself, in the adhesive, in the plastic substrates, etc. see patents above) using a variety of techniques and can cause the media to change from readable to non-readable in response to various stimuli including oxygen (see U.S. Pat. Nos. 6,434,109, 6;343,063, 6,011,772, 6,641,886, 6,511,728, 6,537,635, 6,678,239, 6,756,103, and 5,815,484 and U.S. Patent Application Nos. 20030152019, 20030123379 20030123302, 20030213710, 20030129408, 20030112737, Ser. Nos. 10/649,504, 10/162,417, 10/163,473, 10/163,855, 10/163,472, 10/837,826, 10/163,821, 10/651,627 and 20010046204, hereinafter incorporated by reference in their entirety). In addition, software encoding may be utilized to direct the reading laser to these (or other) particular locations, on the limited play disc to check specific reactive regions so that optimum limited play characteristics are attained.

In the present invention, a corrosive agent is used to inhibit the reading of the encoded information or otherwise prohibit the encoded information from being read by a reading laser via oxygen mediated corrosion of the reflective layer or layers of the optical media structure. This corrosion process results in the destruction of the reflective layer to such an extent that the film no longer has sufficient reflectivity to support the optical reading of the reflective film. The corrosion reaction of the present embodiment involves the utilization of sulfur compounds, and, in particular thioureas or thiourea analogs, the leading example of which is 2-mercaptobenzimidazole (2-MBI, Sigma-Aldrich Catalog # M320-5, Milwaukee, Wis. 53201) which has the ability, in the presence of oxygen, to corrode reflective thin silver layers as are typically found within optical media. It has been demonstrated that stable high quality optical media can be manufactured containing 2-MBI in the bonding agent with standard replicating equipment when newly manufactured discs are stored in a suitable oxygen free atmosphere or substantially reduced oxygen atmosphere and that said discs become unplayable and thus unreadable within a predetermined time period after being exposed to ambient air.

While the exact mechanism for the silver oxidation/corrosion reactions in the present invention has not been determined, a perusal of the literature implicates the unique combination of thin silver/metal coatings and the chemical properties of compounds like MBI. The chemisorption of thioureas and thiourea derivatives like MBI to silver atoms is well known (N Sandhyarani et. al., Journal of Colloid and Interface Science, 209, 154-161 (1999) and references therein; V. T. Joy and T. K. K. Srinivasan, Spectrochimica Acta Part A: Molecular and Biomolecular Spectroscopy, 55, 2899-2909 (1999). Pal discusses the fact that the reduction potential of metals decreases progressively from bulk metal to metal clusters and finally to single atoms (Tarasankai Pal, Current Science, 83, 627-628 (2002). Typical reflective layers in most optical recording media vary from 12 nm (L0) to 55 nm (L1) with thinner areas expected in the information areas (pits). This heterogeneity in the thin silver layer can lead to areas favoring increased air oxidation (Wei Ping Cai et. al., J. Appl. Phys., 83, 1705-1710 (1998); Tarasankai Pal, Current Science, 83, 627-628 (2002)). Pal also demonstrates that the reduction potential of a metal is further lowered in the presence of a nucleophile. Thus, the binding of MBI, a nucleophile, to the thin silver surface may lower the redox potential of the silver, thus making it easier to undergo air oxidation. MBI also has the ability to form complexes with the generated oxidized form of silver, helping to maintain the low oxidation potential in the face of increasing silver ion concentrations (G. I. P. Levenson, “The Theory of the Photographic Process 4^{th} Edition” chapter 15, T. H. James (ed), Macmillan publishing Co. Inc., New York, 1977; U.S. Pat. No. 5,641,616 and references therein). The fact that MBI is reportedly used as an antioxidant in the manufacture of industrial rubber (Zenovia Moldovan, Acta Chim. Slov., 49, 909-916 (20Q2); U.S. Pat. No. 5,666,994) and as an agent to inhibit corrosion of brass, copper and aluminum (Assouli et. al., Corrosion, 60, 604-612 (2004); Robert B. Faltermeier, Studies in Conservation, 44, 121-128 (1999); Khramov, A. N., et. al., Thin solid films, 483, 191-196 (2005)), as well as a corrosion inhibiting agent in radiation curable compositions for optical media (U.S. Patent Application US 2003/0008950 A1) teaches away from the use of MBI in a corrosive mechanism and the observed effects in the present system are unexpected.

In the initial screening tests of the potentially corrosive materials of the present invention, simulated DVD-9 discs were made using the following construction:
injection-molded 0.62 mm polycarbonate substrate with typical DVD-9 L0 data, structure sputter coated with a semi-reflective metallic (silver or silver alloy) film;
bonding agents that contained the potentially corrosive materials of the present invention; nominally 50 μm thick;
injection-molded 0.56 mm polycarbonate featureless (mirror) substrate.

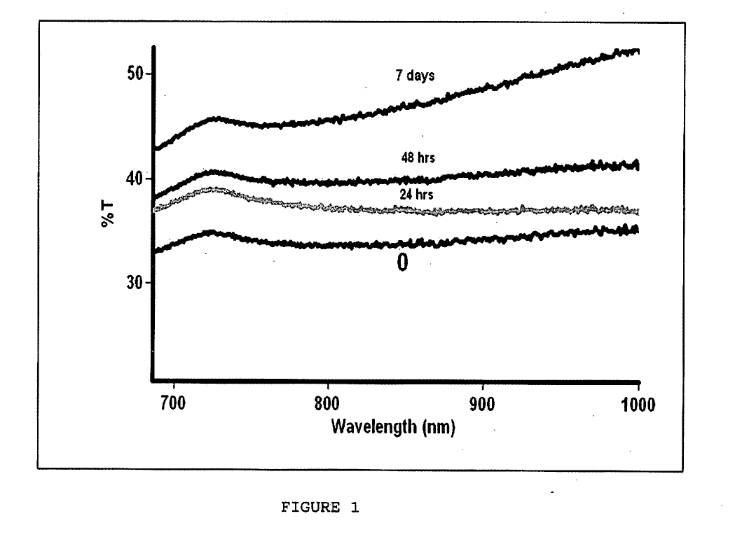

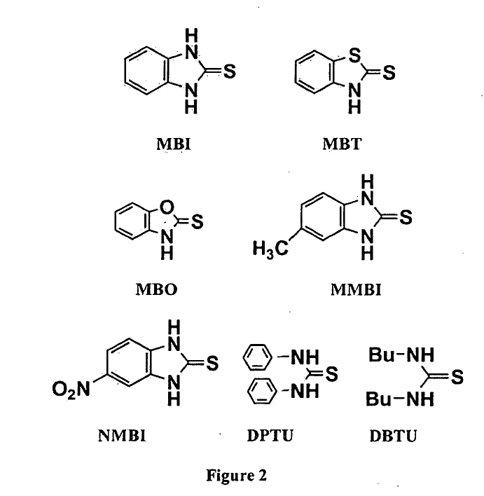

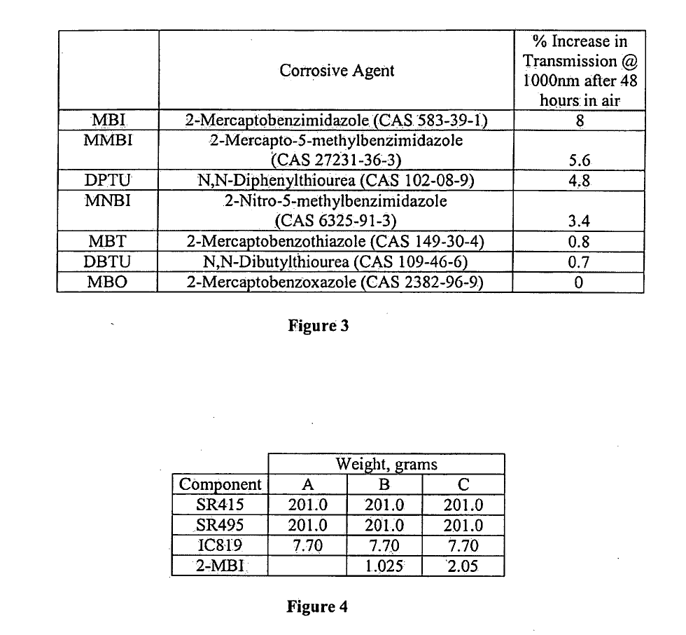

These discs allowed visible-NIR light transmission of the thin L0 silver layer to be monitored; wherein an increase in optical transmission indicates the dissolution, or removal of the reflective metallic silver layer as a result of the action of the corrosive agents of the present invention. As an example of this screening technique, bonding agent formulations which contained 1.0% of the test corrosive agent were used to prepare the simulated DVD-9 discs described above. The particular bonding agent of this test contained greater than 50% by weight of polyethylene oxide moieties, in order to provide some polar character to the reaction matrix. Initial readings of the transmission of the discs were made on a Cary 50 Scan UV-Visible Spectrophotometer and the discs were then stored in the dark at ambient temperature and humidity. Readings were made periodically over a 7 day period. FIG. 1 represents typical transmission spectra from 700 nm to 1000 nm of the L0 layer of the simulated DVD-9 disc that contained 1% MBI in the bonding agent over this 7 day time period; the increasing % T over time is indicative of a loss of silver metal layer as a result of corrosion in the presence of oxygen. Control experiments for the duration of the 7 day test period showed no corrosion in the absence of oxygen or in the absence of MBI. The methods of the preceding experimental description were used to select the most efficient corrosive agent from the sulfur containing agents shown in FIG. 2. MBI was selected as the most reactive corrosive agent with current bonding agent formulations. Results of these tests are shown in FIG. 3. It must be noted that the less reactive materials in this particular test may prove more effective in alternate systems as may occur with variations of bonding agent composition or the need to fine tune performance with less reactive corrosive agents and as such these results are not to be construed as limiting in any way in this or the following examples.

### I. Corrosive Agent Concentration Effects

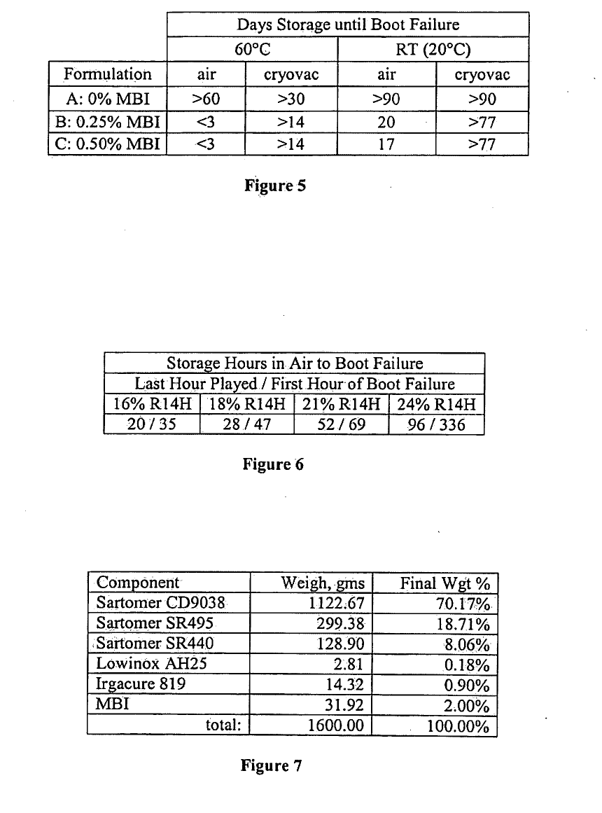

Experimental Example 1. DVD-9 discs were manufactured in typical replication equipment with silver L0 and L1 layers, both on “low gas permeation” polycarbonate utilizing bonding agents that had the compositions shown in FIG. 4. Formulation A was a control that contained no 2-MBI, Formulation B contained 0.25% 2-MBI, and Formulation C contained 0.5% 2-MBI. Common to all three formulations were the following materials: SR415 and SR495 (monomers, Sartomer Company, Inc.; Exton, Pa. 19341), and Irgacure 819 (photoinitiator, Ciba Specialty Chemicals, Tarrytown, N.Y. 10591). Immediately after manufacture, the DVD-9 discs were sealed in plastic packages containing oxygen scavenger material as described in previous patent applications (see U.S. patent application Ser. No. 10/162,417, hereafter incorporated by reference in its entirety). In order to test the time limited playability of discs of the present invention, comparisons were made between discs that had been removed from their oxygen-free package and stored in air and those that remained in the oxygen free packages and played as soon as they were opened. Storage temperatures were room temperature and 60° C. The discs were periodically tested for playability on a typical DVD player (Samsung DVD P-231). The discs were considered to have failed when the player would not recognize that disc (i.e., boot failure). The playability comparison results of this example (see FIG. 5) demonstrate the oxygen dependence of the limited play corrosion based system and also the dependence of the corrosion rate on the concentration of MBI. FIG. 6 is a chart showing the playability comparisons for the limited-play discs made with the silver reflective layer L0's of varying thickness of Experimental Example 2.

### II. Effects of the Adhesive Composition on Corrosion

The present invention demonstrates that the chemical nature of the monomers and additives that are utilized to formulate the bonding agents has an effect on the rate of corrosion of the silver layers. Since it is well known that rates of redox reactions, and particularly metallic corrosion reactions, in polymer media are strongly dependent on the degree of humidity, the incorporation of hydrophilic water attracting materials and humectants will be of advantage in controlling not only the rate of corrosion but also in ameliorating differences in the corrosion rate observed under varying humidities. In particular, the utilization of highly ethoxylated monomers has been found to be advantageous. Examples of these monomers include, but are not limited to, CD9038, bisphenolA diacrylate with 30 units of ethylene oxide; SR415, trimethylpropane triacrylate with 20 units of ethylene oxide; SR610, polyethylene glycol 600 diacrylate; and SR344, polyethylene glycol 460 diacrylate (all available from Sartomer Co.). The cured bonding agents containing MBI typically show increased corrosion rates, and thereby shorter limited life playtimes, as the concentration of ethylene oxide moieties is increased from about 5% by weight up to as high as 80% by weight. Under the above described conditions the preferred level of ethylene oxide was above 40% by weight. Additives and monomers that contain other hydrophilizing groups such as hydroxyl, carboxyl, ethers, amides and amines, and various quaternary salt resulting from the reactions of amines such as 2-(N,N-dimethylamino)ethyl acrylate or methacrylate with a variety of alkylating agents such as methyl chloride, dimethyl sulfate, alkyl sultones, etc, may also be utilized for this purpose. This listing of hydrophilic moieties is not intended to be inclusive and those skilled in the art may combine a wide variety of hydrophilic functionalities, both polymerizable and non-polymerizable, in order to balance the corrosion rates with the physical robustness of the limited play disc.

In the following examples, test discs were assembled in the simulated DVD-9 structure without L1 silver as previously described. The control bonding agent is designated as C100 and was formulated as described in FIG. 7. Sartomer CD9038 monomer contains approximately 82% by weight of polyethylene oxide functionality and thus this complete formulation contains approximately 57% polyethylene oxide. During the test period duration, the discs were stored in chambers that were approximately held at either 85% relative humidity (Wet or less than 20% relative humidity (Dry). The wet chamber humidity was maintained in a sealed one gallon chamber containing a saturated solution of potassium chloride in contact with excess solid potassium chloride. The dry chamber humidity was maintained in a sealed one gallon chamber containing calcium sulfate (Drierite). The rate of corrosion was monitored by observing the change in the optical transmission (% T) at 1000 nm over time; an increase in % T indicates a loss of silver due to corrosion.

FIG. 9 shows the beneficial effect upon the corrosion rates of the L0 silver layer in both wet and dry conditions resulting from the addition of 10 gms tripropylene glycol (TPG, CAS 24800-44-0) to 100 gms of the C100 bonding agent of FIG. 7. This chart shows that the addition of TPG increases the rate of corrosion as well as minimizing the differences between the wet and dry conditions.

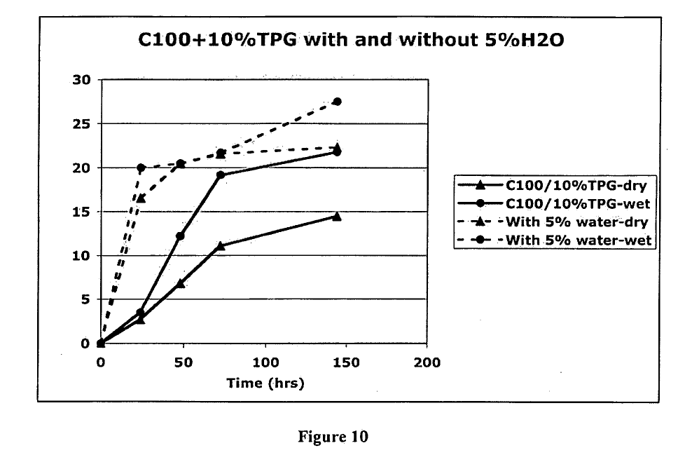

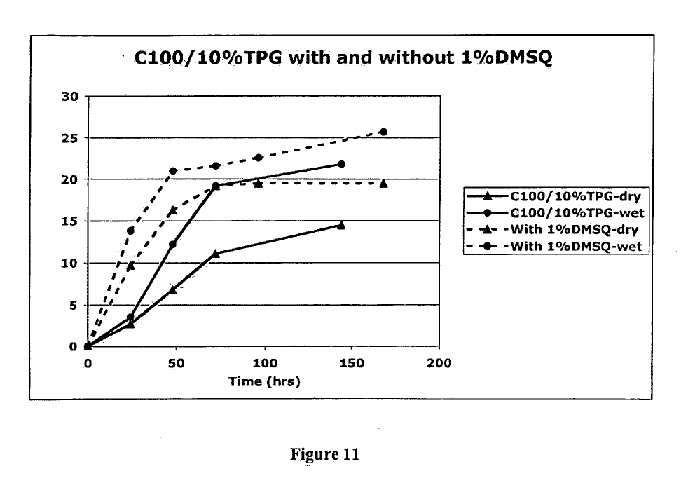

In a similar fashion, FIG. 10 shows the effect of adding 5.0 grams of water and 10.0 grams of TPG to 100 grams of the C100 Bonding Agent used to make the simulated DVD-9 discs. FIG. 11 shows the effect of adding 1.25 grams of [2-(Methylacryloyl) ethyl]-trimethylammonium methyl sulfate (DMSQ, CAS 6891-44-7) and 10.0 grams of TPG to 100 grams of the C100 Bonding Agent used to make the simulated DVD-9 discs. In both cases the corrosion rates were observed to increase for both the wet and dry conditions and the corrosion rate difference between the wet and dry humidity conditions is minimized.

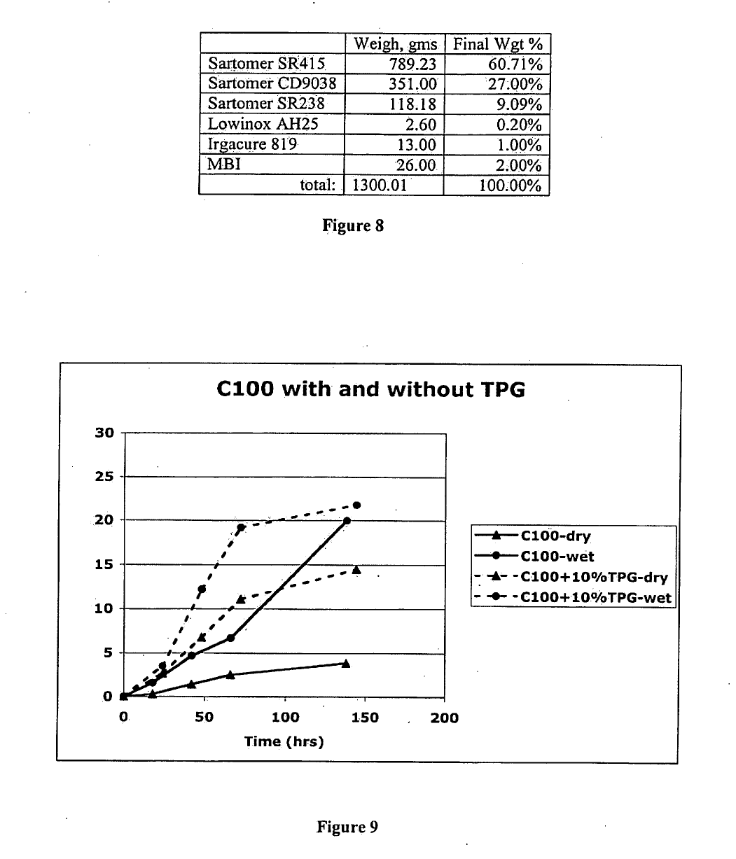

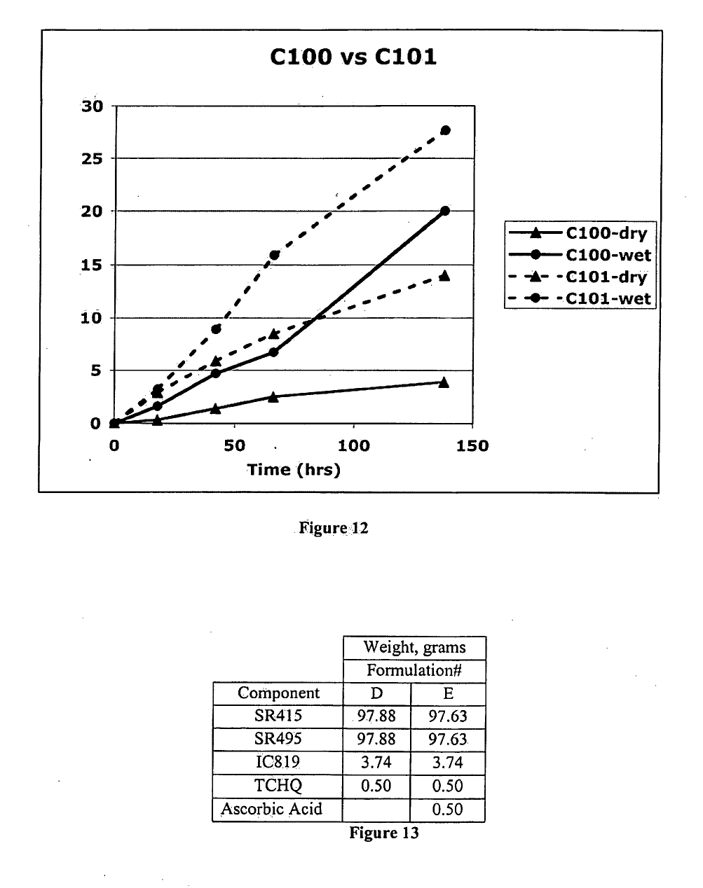

A further example of how changes in the monomer composition of the present invention influence the rate of silver corrosion is shown in FIG. 12 in which the 70% polyethylene oxide containing: C101 Bonding Agent of FIG. 8 was observed to provide a more rapid increase in the % T when compared to the C100 Bonding Agent which contains approximately 57% polyethylene oxide. The Sartomer SR415 and Sartomer CD9038 monomers contain approximately 80% and 82% by weight of polyethylene oxide functionality, respectively, and thus this complete formulation contains approximately 70% polyethylene oxide.

### III. Effects of Reducing Agents in Controlling Corrosion

In another embodiment of the invention, the rate and timing of the corrosion reactions is controlled via the addition of reducing agents. These reducing agents will, after the optical media is exposed to the atmosphere, preferentially react with the initial influx of oxygen until the reducing agent is consumed, at which point the corrosive agent will become active in causing destruction of the reflective properties of the metal layer(s). As an alternative explanation, the reducing agent may cause the active corrosive. materials to exist in a lower oxidation state which is inert to the reflective metal; after the reducing agent is consumed, the corrosive agent precursor is converted (oxidized) by air to form the corrosive material. The following example utilizes tetrachlorohydroquinone (TCHQ) as a non-corrosive precursor in the bonding agent; after exposure to oxygen, TCHQ is oxidized to the benzoquinone form which has a higher oxidation potential and thus is more able to oxidize the reflective silver layers.

Experimental Example 2. The use of reducing agents has been successfully used to control the oxidation of silver layers by tetrachlorohydroquinone (TCHQ) in the bonding agent of the optical media. DVD-9 discs were made with Formulations D and E which contained TCHQ alone and TCHQ in combination with ascorbic acid (see FIG. 13).

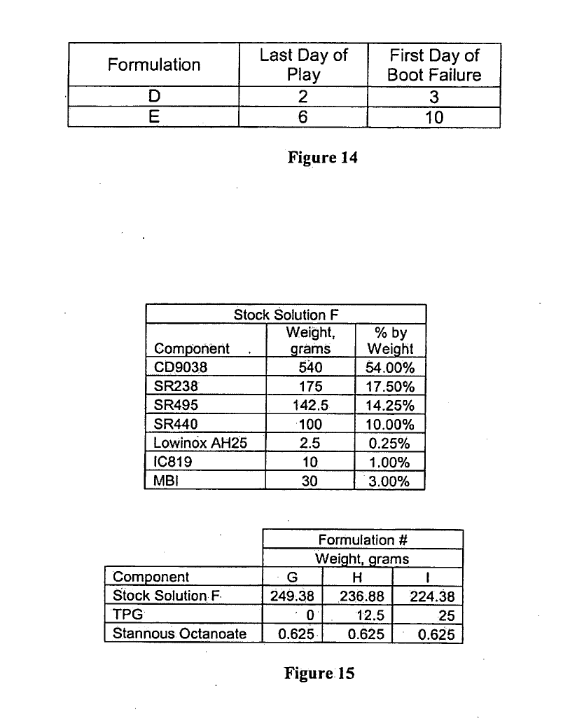

The discs were equilibrated in the absence of air as previously described for one week and then opened and stored in air in a wet chamber to accelerate the corrosion reactions. The discs were tested for playability as described in Experimental Example 1. The results are presented in FIG. 14 in which the increased playtime of formulation E is a direct result of the presence of ascorbic acid reducing agent.

Similar effects of increased playtime have been observed using ascorbyl palmitate and stannous octanoate as reducing agents. Many other reducing agents as described in U.S. patent applications Ser. Nos. 10/163,473, 10/163,855, 10/163,472, 10/837,826, 10/163,821, 10/651,627 and U.S. Pat. No. 6,756,103, all hereafter incorporated by reference, in their entirety, may be applicable here in varying formulations as may be formulated by those skilled in the art.

Stannous octanoate has been found to be useful as a reducing agent for the control of the corrosion based limited-play timing mechanisms of the present invention, but has the unfortunate ability to occasionally cause premature polymerization of typical monomer mixtures. To prevent this, the addition of increased levels of polymerization inhibitors, such as hydroquinones, has allowed the formulation of corrosive bonding agents that exhibit stable viscosities for up to several days in the presence of the stannous salt. In Experimental Example 2, the preferred hydroquinone is 2,5-di-tert-pentylhydroquinone (Lowinox AH250, Great Lakes Chemical Corporation, West Lafayette, Ind.) used at a 0.10% to 1.0% by weight concentration and preferably between 0.2% to 0.5% by weight concentration. Another compound that has shown success in controlling viscosity of monomer formulations in the presence of stannous salts is phenothiazine (CAS 92-84-2; Sigma-Aldrich Cat. No. P14831) when used at similar levels as Lowinox AH25 above.

An additional problem that arises in the use of stannous octanoate with the hydrophilic monomer mixtures that are preferred in the time-controlled corrosive bonding agent systems described above is the formation of hazy mixtures. Presumably, this is a result of poor solubility of the stannous salt in the predominantly polyethylene oxide containing mixture. We have found that clear solutions are formed when stannous octanoate is first dissolved in tripropylene glycol (TPG, CAS 24800-44-0; Sigma-Aldrich Cat. No. 187593). Since TPG is not expected to copolymerize within the cured bonding agents and may exhibit undesirable syneresis, tests were done on peeled discs at 60 degrees C. in order to accentuate the observation of any possible exudation of liquid; no syneresis or exudation was observed under these conditions when TPG was incorporated at levels up to 20% by weight of the cured bonding agent.

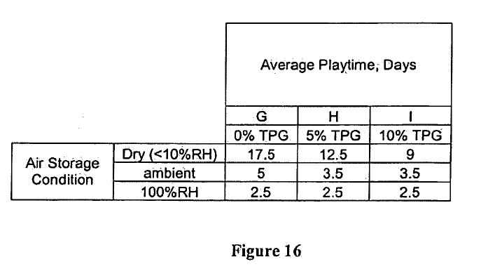

Experimental Example 3 demonstrates that the incorporation of TPG also has a beneficial effect on maintaining a high corrosion rate of silver metal layers in DVD-9 discs even when stored in air under low humidity conditions. Stannous octanoate was pre-dissolved in varying amounts of TPG and combined with Stock Solution F to make Bonding Agents G, H, and I as shown in FIG. 15. The resulting bonding agents contained 2.7%-3% MBI, 0.25% stannous octanoate and 0%, 5%, and 10% by weight TPG. DVD-9 discs were made as described above in Experimental Examples 1 and 2; L0 thickness was specified by a 24% R14H reflectivity and standard grade polycarbonate was used. The discs were stored in oxygen free bags for 4 days, then opened and stored in air at room temperature under the three different humidity conditions, dry (one gallon polyethylene container with desiccant packages), ambient (open to room air), and wet (one gallon polyethylene container with wet paper towels on the bottom). The results shown in FIG. 16 as Average Playtime were determined as the midpoint between the last day that the disc was observed to play and the first day that the disc would not boot on the Samsung DVD Player. These results show that increasing the TPG level has the benefit of reducing the variation in limited playtime between the high and low humidity conditions.

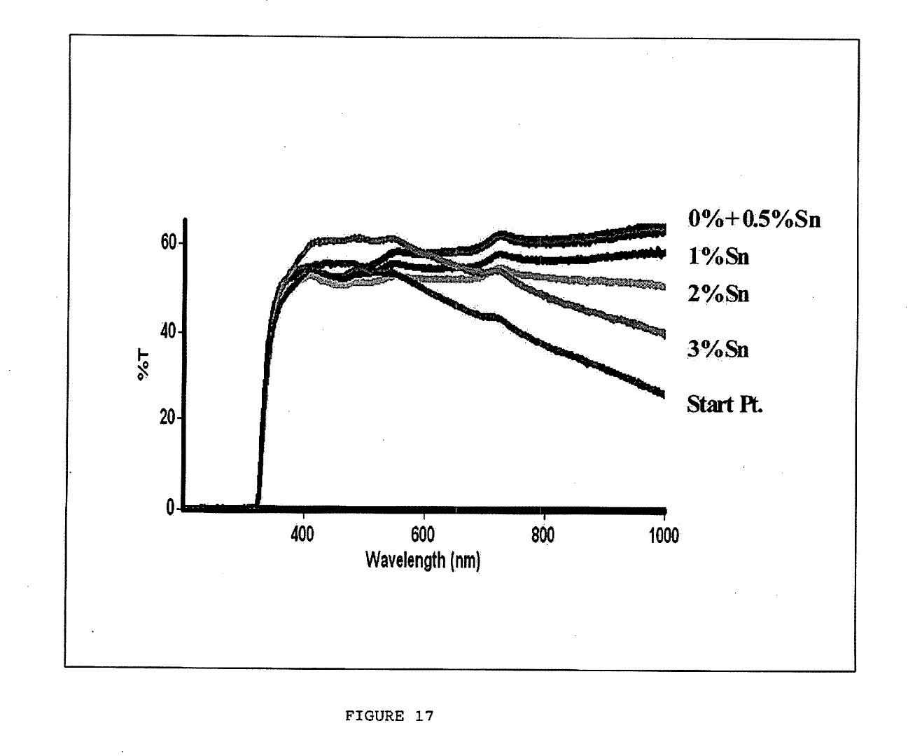

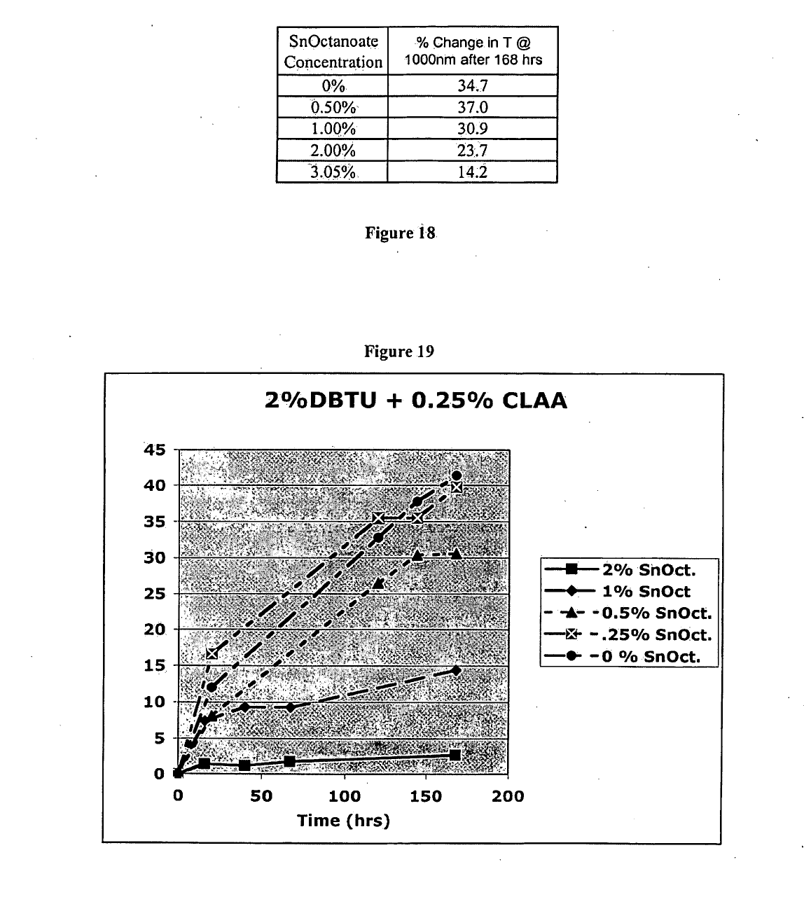

Experimental Example 4 further demonstrates the effect on the rate of corrosion of a simulated DVD-9 disc due to the addition of various levels of stannous octanoate. The varying amounts of stannous octanoate were dissolved in 10.0 grams of TPG and this solution was added to a bonding agent that was made by adding 0.30 grams of 2-chloropropionic acid (CAS 598-78-7) to 100 gms of the C100 bonding agent of FIG. 7. For purposes of comparing the effect of the varying reducing agent concentrations, the simulated DVD-9 discs were stored in 85% relative humidity air at room temperature for 168 hours. Optical transmission spectra were then recorded and are shown in FIG. 17; the increase in transmission from about 600 nm to 1000 nm indicates a loss of silver metal from the semi-reflective layer due to corrosion and that the higher levels of stannous octanoate lead to slower rates of corrosion. The results of this example are also presented in the table of FIG. 18 as the observed change in the % T at 1000 nm over this 168 hour time period. The lower observed changes in % T indicate the slower rate of corrosion as a result of the increasing levels of stannous octanoate.

Experimental Example 5 shows that the ability of SnOctanoate to regulate corrosion rates of silver semi-reflective layers is not restricted to any one combination of corrosive agent or additive but has general applicability to a wide variety of corrosive mixtures. These simulated DVD-9 discs were-made with a stock bonding agent that contained 0.25 grams of chloroacetic acid added to 100 grams of the C100 adhesive of FIG. 7 with the exception that the MBI was replaced with DBTU. Varying levels of stannous octanoate dissolved in 10 grams of TPG was then added to the chloroacetic acid/DBTU bonding agent just described and the simulated DVD-9 discs were bonded. The assembled discs were kept in air in a 60° C. oven and the % T at 1000 nm was measured over time. The results are shown in FIG. 19 as a plot of percent increase in optical transmission vs. time in hours. It is readily observed that the higher levels of stannous octanoate result in a slower increase in optical transmission and thus are effective in slowing the rate of corrosion.

### IV. pH Effects on Corrosion

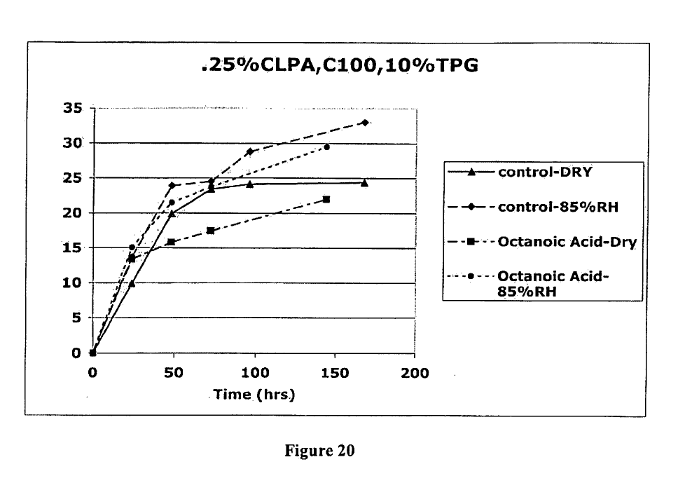

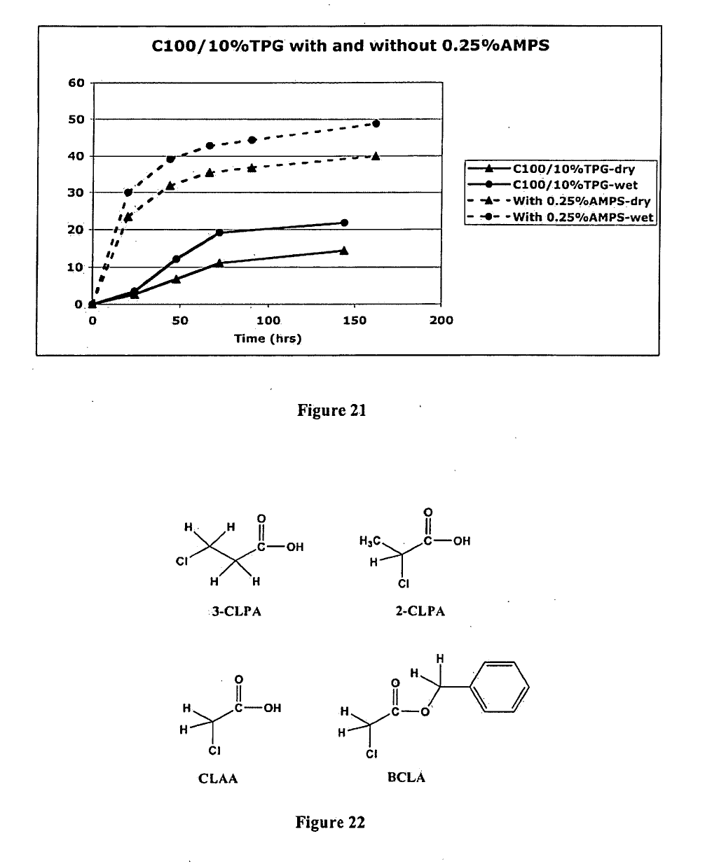

In another embodiment of this invention, we take advantage of the fact that the redox processes involved with corrosion of metallic surfaces are very dependent on the pH of the system (Elementary Electrochemistry, A R Denaro, Butterworths, 1971 (2nd ed); Basic Electrochemistry, J M West, Van Nostrand-Reinhold, 1973; Electrochemical Principles of Corrosion, A Guide for Engineers, L L Shreir, Dept. of Industry, 1982). This pH dependence can be used to control/mediate the corrosion kinetics used in the present invention. Weak acids such as acrylic and phenoxyacetic acid have been observed to increase rates of silver dissolution in most instances, whereas a more hydrophobic carboxylic acid, such as octanoic acid, has been observed to slow silver corrosion rates (see FIG. 20). These contradictory results may be explained by either a direct pH effect, which has been observed to increase the rate of corrosion, or a passivating effect, which may result from the deposition of insoluble carboxylate silver salts or other inhibiting species on the surface of the metal reflective layer via various adsorption phenomenon. Strong acids (phosphates, sulfonic) can be added directly to the reactive layer in the form of pendant groups of monomers/polymers such as 2-acrylamido-2-methyl-1propanesulfonic acid (AMPS) (see FIG. 21) and have been observed to serve as corrosive accelerators. This example shows a large increase in the corrosion rate which is attributed to the AMPS. Simulated DVD-9 discs were made with a bonding, agent that was made by adding 0.25 grams of AMPS and, 10.0 grams of TPG to 100 grams of C100 adhesive; the control bonding agent was made by adding 10.0 grams of TPG to the C100 Bonding Agent. The discs were stored in 85% RH (wet) and ˜20% RH (dry) chambers during the corrosion test period as previously described. The increased rate of corrosion as a result of the AMPS addition is shown by the higher % T in the simulated discs containing the test formulation.

Also disclosed in the present invention is the in-situ release of strong acids (HCl, HBr, HI) through displacement reactions of the general type shown below between mercaptans and halogenated compounds.

RX+HSR¹→HX+RSR¹, where X=Cl, Br, I

The sulfur containing compounds include, for example, but not by way of limitation, mercaptotriazoles, mercaptothiadiazoles, mercaptoimidazoles, mercaptotetrazoles, monothioglycerol, cystine, cysteine, thiourea derivatives, thioamide, alkylene thiols, aromatic thiols etc. These are reacted with haloalkanes, haloalkylacids, haloalkylesters, haloalkyamides etc (see FIG. 22 for examples). Such substances and reactions are known to those skilled in the art and may include selenium analogs of the stated compounds as well as other non-sulfur containing compounds known to react with halogenated compounds to release hydrogen halides.

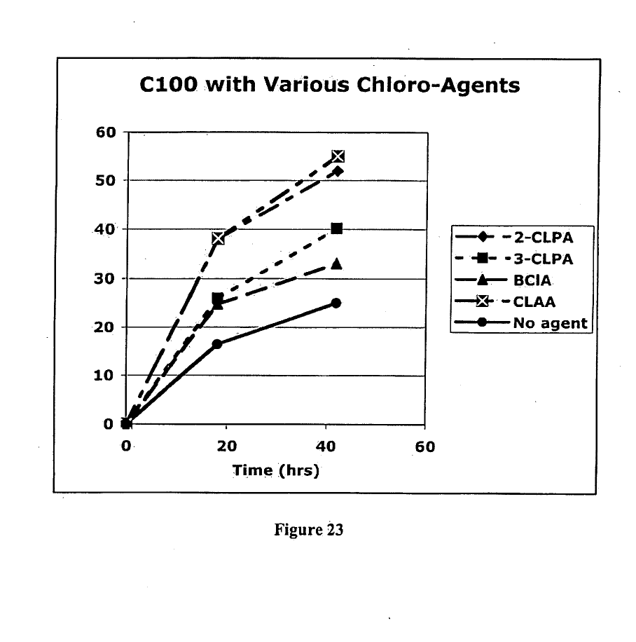

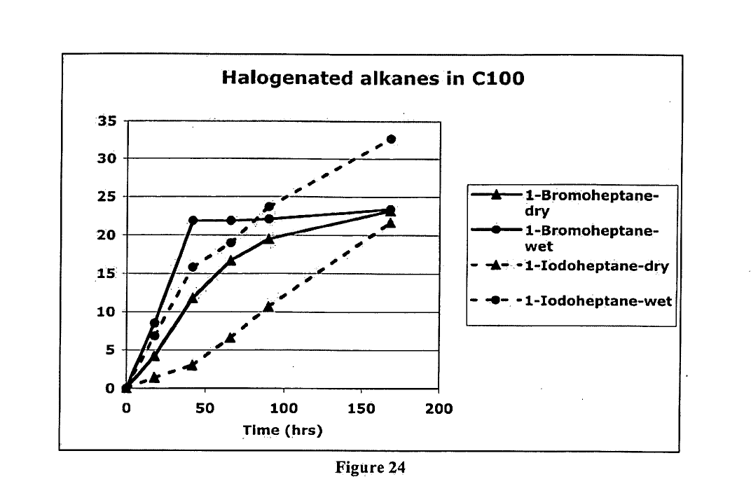

Simulated DVD-9 discs were made with a bonding agent that was made by adding 0.25 grams of the test halocompound of FIG. 22 and 10.0 grams of TPG to 100 grams of the C100 adhesive of FIG. 7; the control bonding agent was made by adding 10.0 grams of TPG to the C100 Bonding Agent. The discs were stored in 85% RH (wet) and ˜20% RH (dry) chambers during the corrosion test period as previously described. The increased rate of corrosion as a result of the addition of the halo-compound is shown by the higher % T in the simulated discs containing the test formulations is shown in FIG. 23. The discs were kept at 60° C. and the % T@1000 nm measured over time. Similarly, the haloalkanes, 1-bromoheptane 1-iodoheptane are shown to be effective in causing increased corrosion of the L0 semi-reflective silver layer in FIG. 24. The discs were kept at various humidities at ambient temperature.

In some cases, it has been observed that the use of halogen containing compounds in combination with MBI has resulted in limited play DVD discs that show minimal playtime variation resulting from storage and playtime testing under widely varying humidity conditions. Longer play times were observed with discs stored and played at lower humidity.

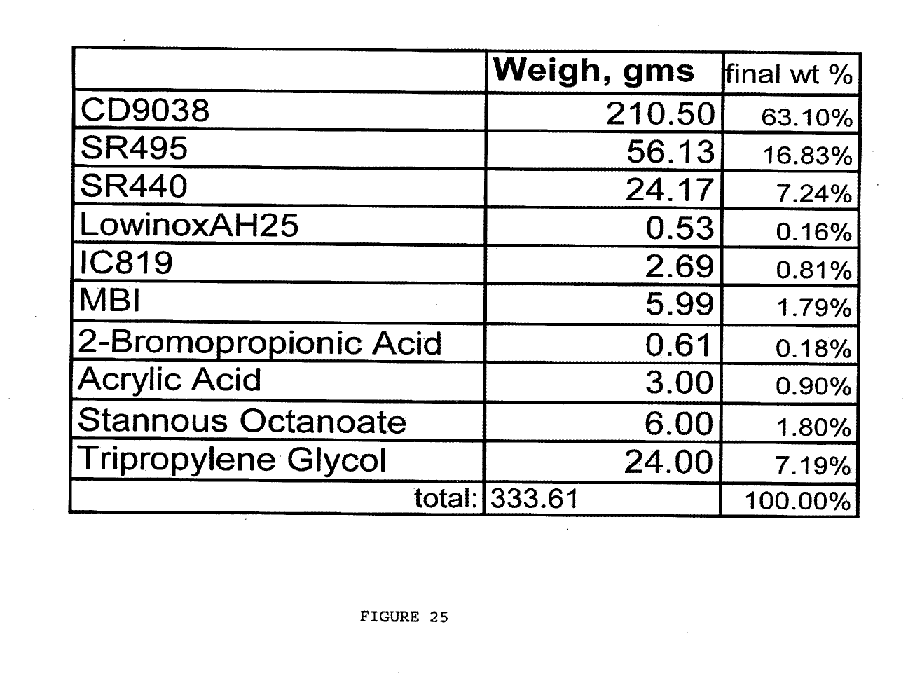

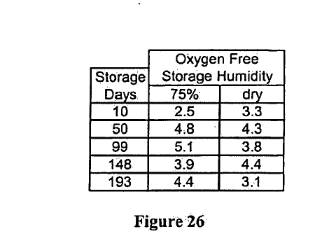

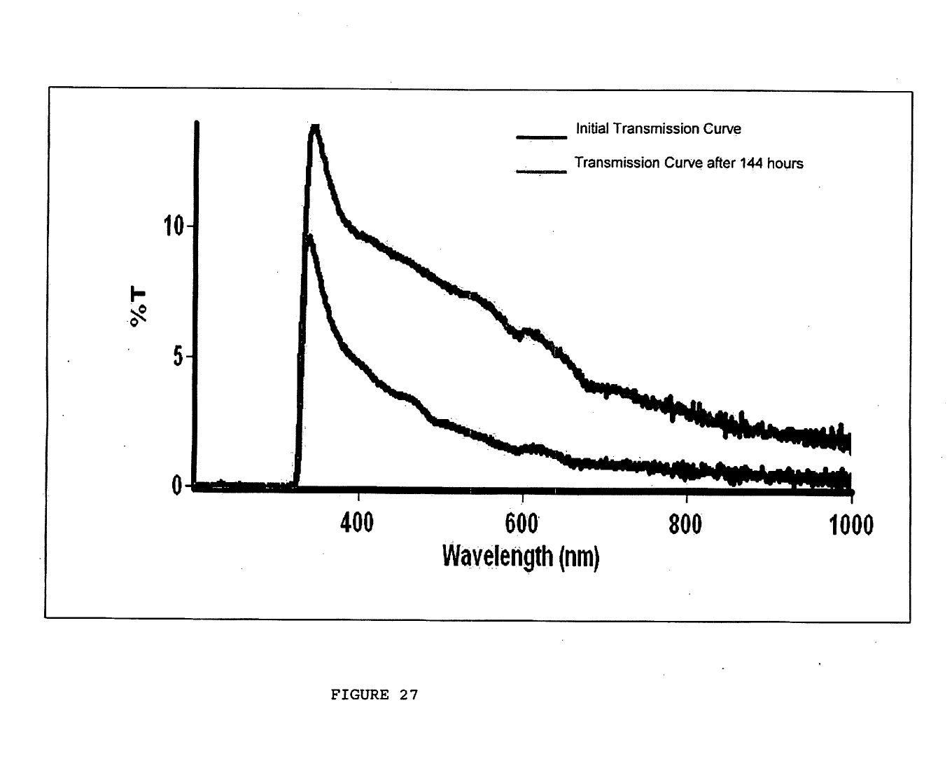

Experimental Example 6 demonstrates that by a judicious choice of reagents and their concentrations, the time limited playtimes observed in both high and low humidities may be very similar. FIG. 25 shows the bonding agent formulation used for this example, and FIG. 26 shows the resulting playtimes of DVD-9 limited play discs made from said bonding layer of FIG. 25. The discs were stored in their individual oxygen free packages in either a 75% RH chamber or a dry chamber as previously described. During playtime testing, the discs, after opening were also maintained in the corresponding humidity controlled chambers.

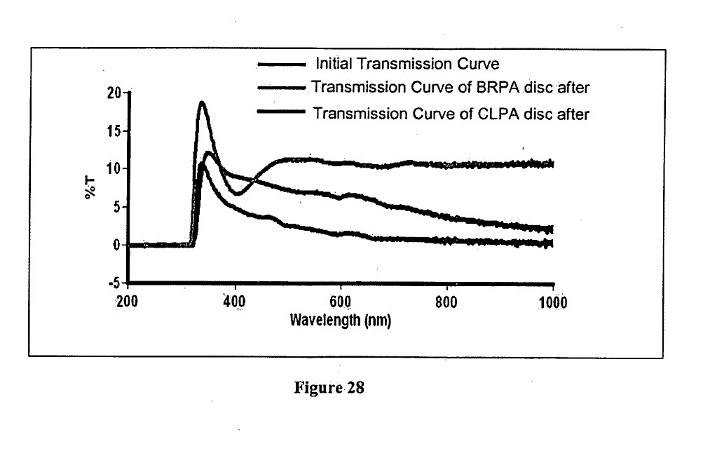

The teachings of the present invention may also be applied to thicker silver metal reflective layers commonly found in a variety of optical media, such as DVD-5 type constructions, the L1 silver metal reflective layer of DVD-9 type constructions, and the thick silver reflective layer of recordable DVD structures. By means of example, the oxidative corrosion of the L1 silver metal reflective layer is shown in FIG. 27 and FIG. 28 by an increase in % T with time. FIG. 27 illustrates results with a bonding agent containing 1.5% 2-chloropropionic acid and 2% MBI in C100 adhesive is used to make simulated DVD-R discs composed of ½ L1 silver coated disc and ½ clear polycarbonate disc. FIG. 28 illustrates results with a bonding agent containing either 1.5% 2-chloropropionic acid (CLPA) or 2-bromopropioic acid (BRPA) and 2% MBI in C100 Adhesive was used to make simulated DVD-R discs composed of ½ L1 silver coated disc, and ½ clear polycarbonate disc. The higher optical transmission from about 350 nm to 1000 nm indicates a loss of silver metal as a result of oxidation and solublization of the silver. These discs were made in a similar manner to the previously described simulated DVD-9 disc but using a silver reflective L1 instead of the previously used silver L0 semi-reflective layer.

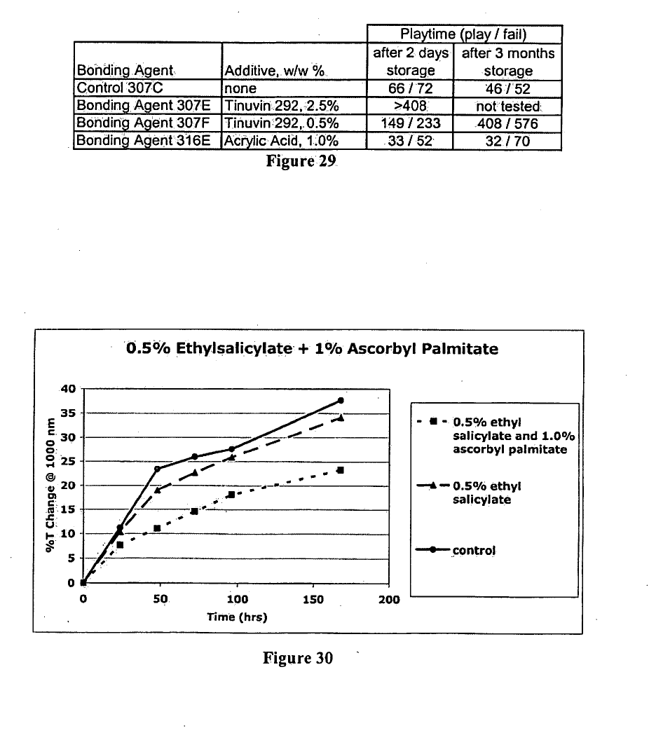

It has also been found that weak amines such as Tinuvin 292 (Ciba Specialty Chemicals, CAS # 41556-26-7, bis(1,2,2,6,6-pentamethyl-4-piperidinyl)sebacate) can inhibit a corrosive reaction. In a comparative experiment, 200 grams of the C100 bonding agent of FIG. 7 was used as the base for the following additions: Contol 307C, no additive; Bonding Agent 307E, 5.0 grams of Tinuvin 292; Bonding Agent 316E, 1.0 grams of Tinuvin 292; and Bonding Agent 307F, 2.0 grams of acetic acid. To each container was also added a solution of 0.375 grams of chloroacetic acid and 3.0 grams of stannous octanoate dissolved in 16.625 grams of TPG. Discs of standard DVD-9 construction were made with the four bonding agents and then immediately stored in the oxygen free packaging as has been previously described. After 2 days of storage and again after 3 months storage, the oxygen free discs were exposed to air and the playtime was checked on a retail DVD player as previously described. During the playtime testing period, the discs were stored in a 44% RH chamber maintained with a saturated solution of potassium carbonate. FIG. 29 shows the results as two numbers, xx/yy, such that xx is the last time in hours that the disc was found to be playable, and yy represents the number of hours that had elapsed when the disc first failed to boot. As can be seen, the basic material, Tinuvin 292, had a slowing effect on the corrosion rate that was dependent on concentration; the higher level actually stopped the corrosion and the disc was playable for up to 408 hours, at which time the test was stopped. The addition of acrylic acid is shown to increase the rate of corrosion when compared to the control.

### V. Effects of Passivating Agents on Corrosion.

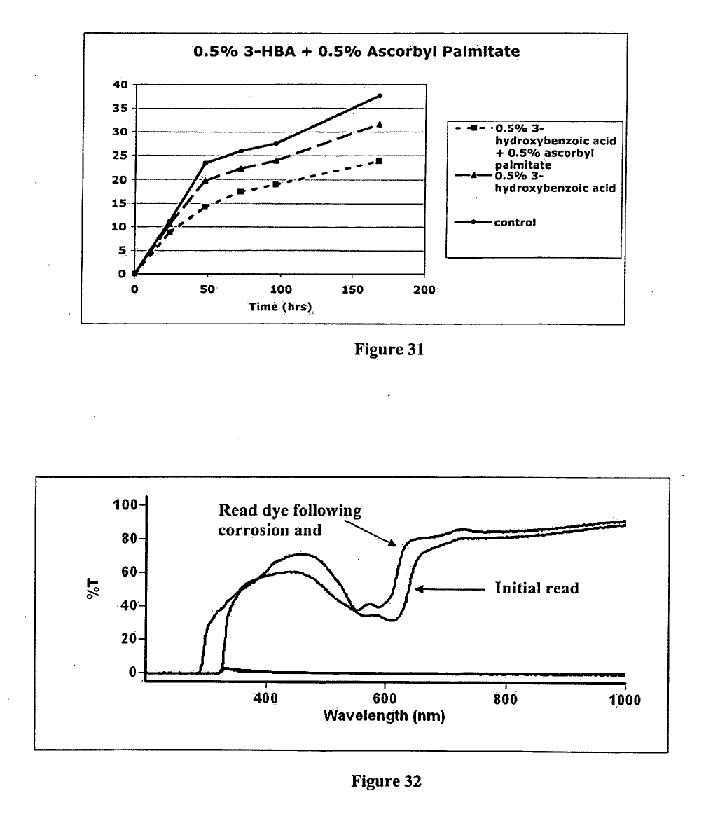

As mentioned above, (see for example FIG. 20) agents which result in the deposition of insoluble or multilayered species on the surface of the metal reflective layer via various chemical reactions or adsorptive phenomenon can result in the partial or total inhibition of corrosion. This approach to corrosion inhibition is extensively studied and practiced by those industries (e.g. electronics, steel, etc.) whose metallic products must be protected from deleterious atmospheric conditions. In the present invention we have taken advantage of passivating agents to help modulate the rate of corrosion and thus the playtime of the optical discs. Among the compounds that may be used for this purpose are those that typically display a lone pair of electrons on atoms such as nitrogen, sulfur and oxygen which are capable of interacting with silver and thus slowing the corrosion rate by competitively binding or interacting with metal surfaces (C. G. Pierpont and C. W. Lange, Prog. Inorg. Chem., 41, p 33 (1994); S. Sanchez-Cortes et. al., Colloids and Surfaces A: Pysicochemical and Engineering Aspects, 176, p 177-184 (2001); Liran Wang and, Yan Fang, J. of Colloid and Interface Science, 265, p 234-238 (2003); W. O. Foye and Jia-Ruey Lo, J. Pharmaceutical Sciences, 61, p 1209-1212 (1972); H. B. Madsen, Studies in Conservation, 16, p 120-122 (1971); C. J. McHugh et. al., Analyst, 129, p 69-72 (2004)). These include but are not limited to sulfur compounds, catechols, resorcinols, hydroxybenzoic acids, aminobenzoic acids, 8-hydroxyquinoline, benzotriazole, imidazoles, pyrimidines, heterocyclic thiones, thiosalicylic acid and salicylic acid derivatives. The present invention also teaches that the regulation of corrosion can also be achieved by combining the appropriate passivating agents with the reducing-agents described above and as shown in FIGS. 30 and 31.

### VI. DVD-R Limited Play Optical Media

The recording dyes used in DVD-R have to meet very demanding requirements including: a high index of refraction and low absorption at the laser wavelength, high contrast of the written pits, high light stability in daylight and under weak laser radiation (reading) while at the same time having a high sensitivity under intense laser radiation (writing) (Jean-Jose Wanegue, Optical disc Systems, March-April 2005). During the writing process, recording dyes are thus carefully selected to absorb light energy at the specific wavelength of the laser used such that the decomposition temperature of said dye layer is reached resulting in the thermal destruction of the dye. This will lead to a change in the optical properties of the dye. Its refractive index that was originally high, is suddenly reduced to a very low value with a concomitant low reflectivity thus creating a contrast between recorded marks and intervals where the dye is unwritten. Because of these highly sensitive and precise requirements for recording dyes, a DVD-R disc may be made as a limited play disc by utilizing recording dyes that provide the required thermal decomposition characteristics, absorption spectrum, extinction coefficient and refractive index, but with photochemical stability of an order that a reading laser may affect the above mentioned properties in such a manner that the disc becomes unreadable in a predetermined time frame or after a number of reads. For example, it is known to those in the art of recordable dye manufacture that dyes with a relatively low heat resistance can be generally used to advantage in order to write information using a lower power laser beam. However, when these dyes are exposed to a laser beam for a relatively long period of time on reading, this positive attribute is offset by the dyes tendency to accumulate heat and deform parts around pits and other pit less parts on recording surfaces resulting in large jitters and reading errors (see Jean-Jose Wanegue reference above). This enhanced exposure may be provided by software encoding to direct the reading laser to a particular spot on said limited play encoded DVD-R disc or to check regions so that optimum limited play characteristics are attained. Said dyes or dye layers are envisioned to be functional in the range of wavelengths from 400 nm to 800 nm, which are typical for lasers used in recordable systems such as Blu-ray-R, HD-DVD-R, DVD-R and CD-R.

As a further example of light induced recording dye decomposition leading to play failure, movies were successfully recorded and played on a Maxell DVD-R and an Imation DVD-R and then half of each disc was covered with aluminum foil. These discs were mounted onto a board, and the board was placed in open air sunshine for three days, at which point the Imation disc was observed to have lost most of the recording dye color in the exposed area. At the end of the exposure time, the Imation disc booted and the chapters 1-6 played normally, but later chapters failed to play (frozen screen or pixilated). The Maxell disc played normally (all chapters). After one more day in sunlight, the Imation disc would not boot. Although the dye changes due to light exposure in this example are most likely a result of the UV component of sunlight, this example is merely presented to show that light induced changes in the recording dye can be used to prevent viewing of a recorded DVD after a certain exposure. A properly selected recording dye that shows instability and chemical changes at the wavelength of the reading laser will have potential use in making a limited play recordable DVD.

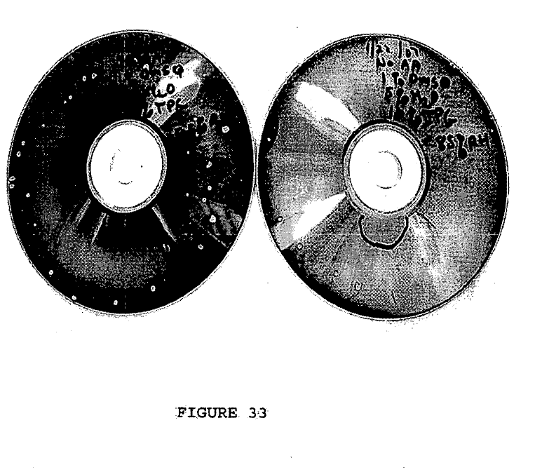

Limited play recordable optical media may also be made by the release of a dye solvent or diffusible material as a result of the recording process (i.e. via thermal or photolytic processes). Said released diffusible material will diffuse in a timed manner into the dye layer and change its optical properties such that playback will fail. For example, said diffusible material may cause changes in the absorption characteristics due do solvochromic effects or concentration changes due to dye migration thus altering optimal reflectivity arid contrast characteristics required for effective play back. Alternately, the reflective layers and dye layers may be optimized so that the recording process generates pinholes, weakened areas, or is otherwise made susceptible to direct diffusion or delayed diffusion of dye starting at the time of recording. The timing of the play period window may be controlled by the chemical nature and variation in the concentration of diffusible material in the bonding agent or by controlling the level of reflective metal layer defects that arise from the rigors of the recording process. FIG. 32 shows the spectral changes that occurred in a recordable DVD disc as a result of the use of a bonding agent that promoted corrosion of the reflective layer with subsequent diffusion of the recording dye from the recording side of the metal layer, through the metal layer, and into the bonding agent. FIG. 33 shows how the addition of the proper reagent, in this case-acrylic acid, can be used to control this dye diffusion. Bonding layer contained 4% acrylic acid, 5% water, 1% [2-(Methylacryloyl)ethyl]-trimethylammonium methyl sulfate in C100 adhesive. Disc on right did not contain acrylic acid and shows far less dye mobility.

Limited play recordable optical media may also be made by the incorporation of a material or materials such that the burning process generates delayed or tired effects or errors in the resulting reading processes. For instance, such defects or errors may result from crystallization in the adhesive layer which has been seen to deform the reflective metal/dye layer interface. Any combination of the above effects may also be used to make a limited play recordable optical media.

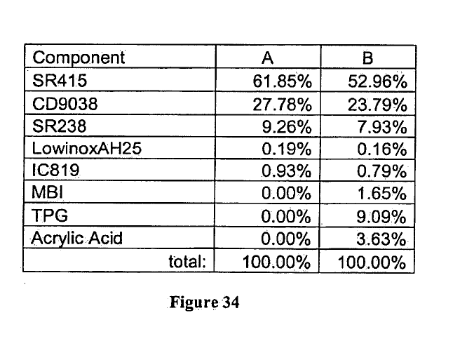

Experimental Example 7. The concepts of the present invention may be applied to typical recordable DVD's. Time limited playback functionality incorporated into recordable discs was demonstrated in the following example. Recordable discs were made with a control bonding agent A and an active chemistry containing bonding agent B which were formulated in the ratios shown in FIG. 32. The discs were assembled in the following order:
injection-molded 0.62 mm polycarbonate substrate with typical DVDR tracking groove structure; coated with a typical recording dye layer; sputter coated with a fully reflective metallic (silver alloy) film;
bonding agent: compositions described above as Control Formulation A or Active Formulation B; nominally 50 μm thick (FIG. 34 is a chart showing bonding agent formulations that were used in time limited recordable DVD example, wherein Formulation A is a control without the active corrosion chemistry components (MBI, TPG, Acrylic Acid) of Formulation B.)
injection-molded 0.56 mm polycarbonate featureless (mirror) substrate.

Within one hour of manufacture, the finished discs were sealed inside a package that contained an oxygen scavenger, and the packaged discs were stored at ambient room conditions. After six days storage, two discs of each bonding agent formulation were removed from their oxygen free packages and content was recorded on each disc at 16× writing speed. All of the recorded discs were found to play properly without signs of errors, i.e., pixelation or freezing. The recorded discs which contained the time limiting chemistry were then placed into a series of automated DVD players which automatically check the playability of the discs every 15 minutes. Two of the discs, which were held at approximately 58% relative humidity during the testing period, failed to boot after 4.6 and 4.4 days, respectively. Similarly, two discs held at 87% relative humidity during the testing period failed to play after 3.4 days, respectively, and two discs held at 23% relative humidity during the testing period failed to play after 3.6 and 3.7 days, respectively. The burned discs that contained the control bonding agent formulation A continued to play for greater than one month while stored at room temperature. Before the recording process, the discs which contained the time limiting chemistry of bonding agent formulation B were stable for up to two months when stored in the oxygen free packages as previously described. The recorded discs which contained the time limiting chemistry of bonding agent B were resealed immediately into the oxygen free packaging after the recording process and after storage at room temperature were viewable for up to one month when opened.

Although the invention has been described in considerable detail in the preceding examples, this detail is for the purpose of illustration and is not to be construed as limitation on the scope of the invention as described in the pending claims. All U.S. patents and published patent applications identified above are incorporated herein by reference.

What is claimed is:

1. An optical media comprising:
a substrate, wherein said substrate includes information encoding features encoded therein;
a reactive layer, wherein said reactive layer has the capability of altering the reflective properties of the reflective layers upon exposure to air; said reactive layer comprising, one or more reactive materials, wherein said reactive materials are harmless to the reflective layers in the absence of air and further causes the alteration of the reflective layers in the presence of air.

2. The optical media according to claim 1, where at least one of said reactive materials is a sulfur containing compound.

3. The optical media according to claim 2, where at least one of said sulfur containing compounds is a thiourea compound, analog, or derivative.

4. The optical media according to claim 2, whereat least one of said sulfur containing compounds is 2-mercaptobenzimidazole.

5. The optical media according to claim 4 wherein the concentration of 2-mercaptobenzimidazole is between 0.25-4% and preferably between 0.5% and 2%.

6. The optical media according to claim 1, further comprising a reducing agent.

7. The optical media according to claim 6, wherein said reducing agent is selected from soluble Sn(II) compounds, soluble iron (II) compounds, reducing saccharides, ascorbic acid and its derivatives, hydroxylamines, hydrazines, dithionites with a solubilizing counter ion, alpha-hydroxyketones, appropriately substituted boron and silicon hydrides, and combinations thereof.

8. The optical media according to claim 6, wherein said reducing agent is stannous octanoate or ascorbyl palmitate.

9. The optical media according to claim 1, wherein the composition of the bonding agent contains 10-90% by weight of polyethylene oxide moieties.

10. The optical media according to claim 8, wherein the composition of the bonding agent contains greater than 50% by weight of polyethylene oxide moieties.

11. The optical media according to claim 1, further comprising an acidic agent.

12. The optical media according to claim 11, wherein the acidic agent is a weak acid.

13. The optical media according to claim 12, wherein the acidic agent is acrylic acid.

14. The optical media according to claim 13, wherein the acidic agent is 0.25%-10% acrylic acid but preferably between 0.5% and 4% acrylic acid.

15. The optical media according to claim 11, wherein the acid is generated in-situ.

16. The optical media according to claim 15, wherein the acid is generated through displacement reactions between thiols and halogenated compounds.

17. The optical media according to claim 16 wherein the thiol is 2-mercaptobenzimidazole and the halogenated compound is 2-chloropropionic acid.

18. The optical media according to claim 17 wherein the concentration of 2-mercaptobenzimidazole is the same as in claim 5 and the 2-chloropropionic acid concentration is between 0.1% and 3% but preferably between 0.25% and 0.50%.

19. The optical media according to claim 1, further comprising a humectant.

20. The optical media according to claim 19, wherein the humectant is 5-20% tri(propylene glycol).

21. The optical media according to claim 1 wherein the passivating agent is elected from any class of compounds known to interact with the silver surface such as sulfur compounds, metal complexing agents, catechols, imidazoles, pyrimidines, heterocyclic thiones, aminobenzoic acids, hydroxybenzoic acids and combinations thereof.

22. The optical media according to claim 21 wherein said passivating agent is 0.25%-2.0% ethyl salicylate.

23. The optical media according to claim 21 wherein said passivating agent is 0.25%-2.0% ethyl salicylate in combination with 0.25%-2.0% ascorbyl palmitate.
